(19) United States
(12) Patent Application Publication
(10) Pub. No.: US 2004/0187556 A1
(43) Pub. Date: Sep. 30, 2004

(54) Method for measuring coefficient of friction

(76) Inventors: Hironari Abe, Tokyo (JP); Toshio Sawa, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/488,326

(22) PCT Filed: May 22, 2002
(86) PCT No.: PCT/JP02/04939

(51) Int. Cl. G01N 19/02

(52) U.S. Cl. 73/9; 73/10

(57) ABSTRACT

The present invention relates to a method for measuring a coefficient of friction by which a coefficient of static friction and a coefficient of dynamic friction at such places utilized by people as the paved surfaces of sidewalks, promenades, or amusement parks, or the floor surfaces of buildings, gymnasium and the like.

Then, it is the object of the present invention to provide a method for measuring a coefficient of friction by which a coefficient of friction, that is, a coefficient of static friction and a coefficient of dynamic friction at low speeds, between a walking person and a floor surface.

For this object, according to the present invention, a device including a measuring device body (A) and a controller (B) is used. In the measuring device body (A), a friction measuring part (1) and a driving part (2) are supported by a holder (4) mounted on the base frame (3) of the measuring device body (A), an actuator (5) is provided for moving up and down the holder (4), a driving disc (12) having large inertia is fixed to a driving shaft (11), further, a disc (13) having small inertia is rotatably mounted on the driving shaft (11), the driving disc (12) is connected to the disc (13) by a balance spring (14), a contact body (19) for measuring a coefficient of friction is mounted on the disc (13), and there are provided a displacement gage (15) for detecting the displacement of the balance spring (14) and a tachometer (24) for detecting the rotational speed of the driving disc (12). Then, the controller (B) drives a motor (21) in a state where the contact body (19) is in contact with a surface (G) to be measured and receives the rotation signal of the tachometer (24) and the displacement signal of the displacement gage (15) to compute the coefficient of static friction and the coefficient of dynamic friction.

### TECHNICAL FIELD

The present invention relates to a method for measuring a coefficient of friction by which a coefficient of static friction and a coefficient of dynamic friction at such places utilized by people as the paved surfaces of sidewalks, promenades, or amusement parks, or the floor surfaces of buildings, gymnasiums and the like.

### BACKGROUND ART

The present inventor proposed an effective device as a device for measuring a coefficient of dynamic friction of roads for automobiles, runways for airplanes, or ground in the specification of U.S. Pat. No. 4,594,878, Japanese Examined Patent Publication No. S57(1982)-23212, Japanese Examined Publication No. H3(1991)-10062.

Such a device is a small-sized, portable type device and makes measurement so easy that it does not produce individual variations and takes such a short time for the measurement that it is extremely convenient. Moreover, by using a technique for measuring a coefficient of dynamic friction of a road surface, for example, by mounting a material of tire on a rotating body, this device can determine a coefficient of dynamic friction between the road surface and the specific material mounted.

Moreover, even if small bumps and dips or joints are on the road surface to be measured, the device is not affected by them in the measurement and can perform the measurement even on a slight slope and further can directly measure a coefficient of dynamic friction by an on-the-spot work because it is the portable device.

In recent years have increased occasions for measuring a coefficient of friction, that is, a coefficient of static friction between a walking human body and a floor surface for the purpose of securing safety. Moreover, in some cases, it is required to measure a coefficient of dynamic friction at low speeds. However, a device in the prior art for measuring a coefficient of dynamic friction is that for measuring a coefficient of dynamic friction between an automobile running at high speeds or the like and the road surface and thus can not measure a coefficient of static friction with facility.

As the results of various researches, the present inventor has found that the coefficient of static friction can be measured without difficulty by the use of the conventional device.

Therefore, it is an object of the present invention to provide a method for measuring a coefficient of friction by which a coefficient of static friction between a contact body, for example, the shoes of a walking person and a surface to be walked, that is, a paved road surface or a floor surface can be measured with facility.

It is another object of the present invention to provide a method for measuring a coefficient of friction by which a coefficient of static friction and a coefficient of dynamic friction at low speeds of a surface to be measured can be obtained by the same device.

### DISCLOSURFE OF THE INVENTION

According to the present invention, in a method for measuring a coefficient of friction by using a device for measuring a coefficient of friction, including a measuring device body having seats provided at corners of a bottom surface of a base frame, a holder mounted on the base frame and for supporting a friction measuring part and a driving part, an actuator mounted on the base frame and for moving up and down the friction measuring part and the driving part via the holder, a driving disc fixed to a driving shaft extending from the driving part, a disc rotatably mounted on the lower shaft of the driving disc, the driving disc being joined to the disc by a balance spring, a contact body mounted on a bottom surface of the disc and for measuring a coefficient of friction, and a displacement gage for detecting a displacement of the balance spring; and a controller having a keyboard for inputting measurement conditions, a display for showing data and a control part, the measuring device body is placed on a surface to be measured in a state where it contacts the surface, and a force applied at that time by the contact body to the surface to be measured is previously determined, and the driving disc is rotated to displace the balance spring, and the controller computes a coefficient of static friction from the displacement of the balance spring at the time when the disc starts to rotate and the load of the contact body and shows it on the display.

Further, according to the present invention, water is previously splayed on the surface to be measured before measurement to measure a coefficient of static friction.

Still further, according to the present invention, the disc is rotated to a predetermined number of revolutions in a state where the disc is pushed up and then the disc is moved down to be put into contact with the surface to be measured to thereby measure a coefficient of dynamic friction by the number of revolutions of a tachometer and the displacement of the balance spring at that time.

Still further, in this case, it is also recommended that water is sprayed on the surface to be measured before measurement to measure a coefficient of dynamic friction.

Therefore, when the device body is placed on the surface to be measured and the contact bodies on the disc are brought into a state of contact with the surface to be measured and then the driving disc is rotated, the balance spring is extended and the disc starts to rotate. The controller can compute a coefficient of static friction from the displacement of the balance spring at the time when the disc starts to rotate and show it on the display.

Moreover, when water is sprayed, it is possible to measure the coefficient of static friction of the surface to be measured in a wet state.

Therefore, the method according to the present invention can be suitably applied to the paved surfaces of automobile roads, the floor surfaces of buildings or the like, the floor surfaces of common areas of condominiums or the like, and the floor surfaces of sporting facilities such as gymnasium and the like.

Further, by switching the controller to a circuit for measuring a coefficient of dynamic friction, it is possible to measure also the coefficient of dynamic friction at a low speed, for example, at a speed of from 0 to 15 km/h from the displacement of the balance spring and the number of revolutions.

Still further, in a case where the measuring of the coefficient of dynamic friction at a high speed, for example, more than 20 km/h is required, it can be performed by the mode described in the specification of the above-mentioned U.S. Pat. No. 4,594,878.

In this manner, according to the present invention, it is possible to measure the coefficient of static friction and, if necessary, also the coefficient of dynamic friction at any location, and further in a dry state and a wet state. Thus, this is extremely convenient.

### BRIEF DESCRIPTION OF THE DRAWINGS

FIG. 1 is a perspective view of a device for measuring a coefficient of friction in accordance with the present invention.

FIG. 2 is a cross-sectional view of a measuring device body.

FIG. 3 is a bottom view of the measuring device body.

FIG. 4 is a block diagram of the device for measuring a coefficient of friction.

FIG. 5 is a flow chart showing the operation of the device for measuring a coefficient of friction.

FIG. 6 is an illustration of one example of data of a coefficient of static friction shown on a display.

FIG. 7 is an illustration of one example of data of a coefficient of dynamic friction shown on a display.

### BEST MODE FOR CARRYNG OUT THE INVENTION

The preferred embodiments of a method for measuring a coefficient of friction in accordance with the present invention will be described with reference to the drawings.

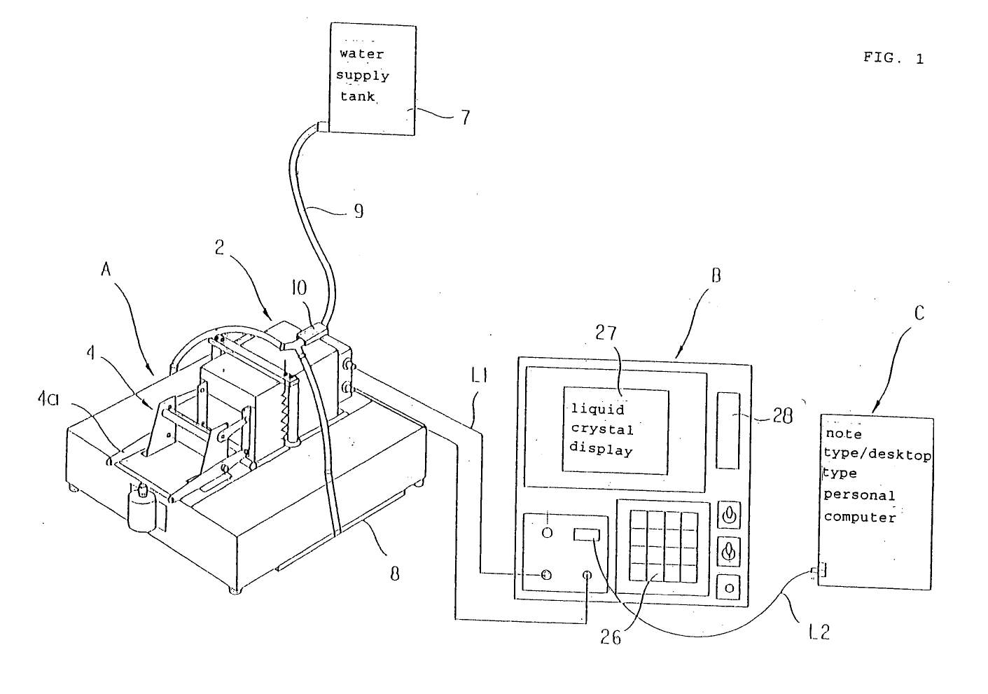

As shown in FIG. 1, a device for measuring a coefficient of friction used for a method for measuring a coefficient of friction is constituted by a measuring device body A and a controller B connected to the measuring device body A by a signal line L1. Here, the controller B can store about 100 measurement data. Then, the signal line L2 of a personal computer C is connected to the controller B and the personal computer C is adapted to collect the measurement data stored in the controller B.

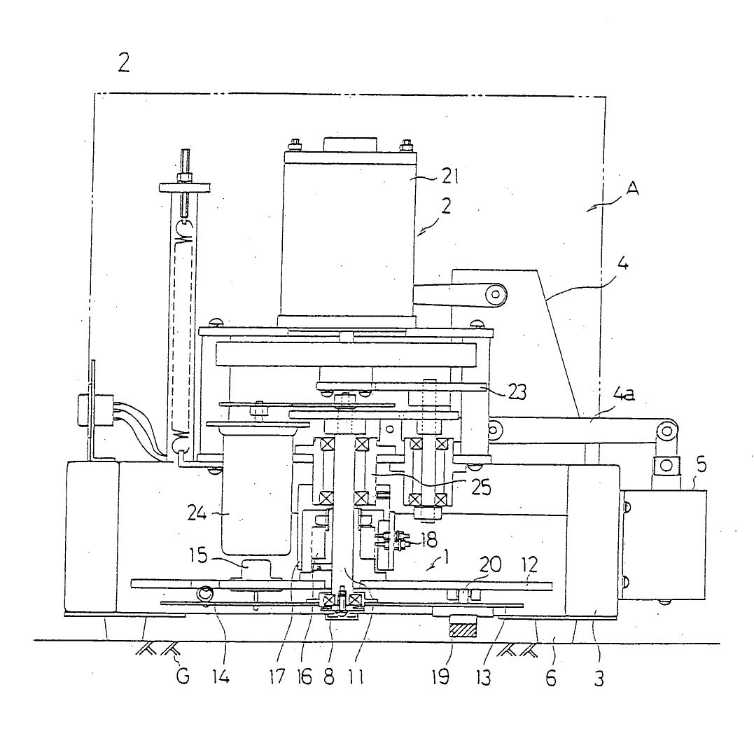

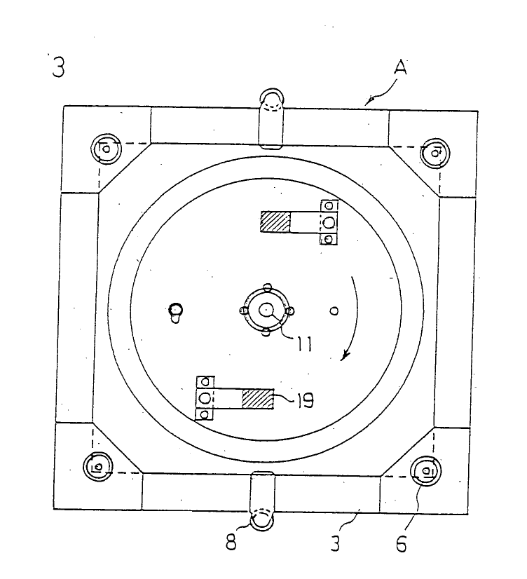

As shown in FIG. 2 and FIG. 3, the friction measuring part 1 of the measuring device body A is rotated by a driving part 2 and the driving part 2 is supported by a holder 4 fixed to the top of the base frame 3. This holder 4 is a link mechanism and is provided with an actuator 5 for moving up and down the lever 4a of the holder 4. When the actuator 5 receives a driving signal via the signal line L1 from the controller B, it operates the lever 4a to move up the driving part 2 together with the friction measuring part 1.

Moreover, rubber seats 6 are provided on four corners of the bottom surface of the base frame 3 and these rubber seats 6 can stably set the measuring device body A on a surface G to be measured even if the surface G to be measured has small bumps and dips or is slightly inclined.

A water spray nozzle 8 directed to the friction measuring part 1 is provided inside on the bottom surface of the base frame 3 and a water supply tank 7 is connected to the water spray nozzle 8 by a pipe 9, and a water supply valve 10 is interposed in the pipe 9. Then, when the water supply valve 10 receives a valve opening signal via the signal line L1 from the controller B, it is opened to spray water in the water supply tank 7 from the water spray nozzle 8 to the surface G to be measured.

A driving disc 12 having large inertia is fixed to the driving shaft 11 of the friction measuring part 1 and a disc 13 having small inertia is rotatably mounted to the lower driving shaft 11 of the driving disc 12. The driving disc 12 is joined to the disc 13 by a balance spring 14. Thus, the disc 13 is rotated with the driving disc 12 via the balance spring 14. A displacement gage 15 which when a load is applied to the disc 13, measures the displacement of the balance spring 14 and converts it into an electric quantity is provided between the driving disc 13 and the disc 12.

In this respect, instead of measuring the displacement of the balance spring 14 by the displacement gage 15, it is also recommended that a rotational phase difference between the driving disc 12 and the disc 13 be measured.

A slip ring 16 is fixed to the top surface of the driving disc 12 and a brush 18 is provided on a cylinder 17 planted in the bottom surface of the case of the driving part 2. Then, a displacement signal produced by the displacement gage 15 is taken out of the slip ring 16 via the brush 18 and is sent the controller B via the signal line L1.

Two contact bodies 19 for measuring a coefficient of friction are fixed, concentrically with the driving shaft 11, to the bottom surface of the disc 13 and a vertical load is applied to the contact bodies 19 by a roller 20 mounted on the bottomed surface of the driving disc 12. That is to say, the disc 13 mounted with the contact bodies 19 is engaged with the surface G to be measured by its own weight and the weight is previously determined to be, for example, 2 kg. The contact body 19 is a leather plate in a case where a coefficient of friction between the surface G to be measured and leather shoes is measured and a rubber plate in a case where the surface G to be measured and sport shoes is measured. The contact body 19 can be replaced according to conditions for determining the coefficient of friction.

The motor 21 of the driving part 2 is supported in the case of the driving part 2 and rotates the driving shaft 11 via a gear mechanism 23, and the driving shaft 11 is supported by a bearing 25 mounted on the bottom surface of the case of the driving part 2, and the friction measuring part 1 is moved up and down integrally with the driving part 2 via the driving shaft 11. Then, there is provided a tachometer 24 for measuring the number of revolutions of the driving disc 12, and when the motor 21 receives the driving signal of the controller B via the signal line L1, it is rotated and a rotation signal from the tachometer 24 is sent to the controller B via the signal line L1.

The controller B is provided with a key board 26 for inputting measurement conditions, for example, the state of the surface to be measured, the kind of coefficient of friction to be measured, the location of measurement, the date of measurement, measuring person, the start of measurement and the like, a display 27 for showing the results of measurement, and a control part 28.

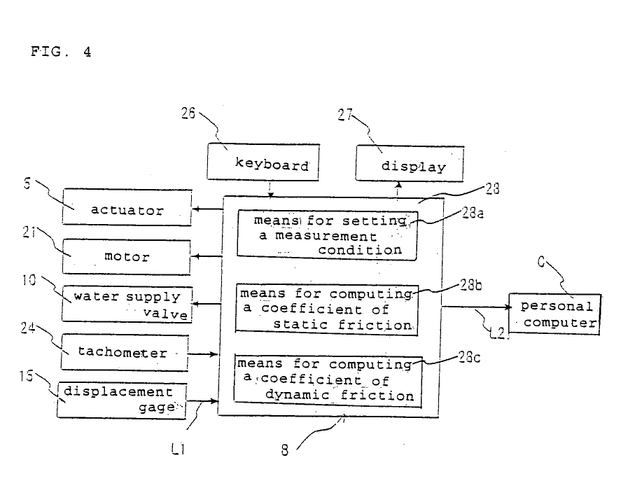

As shown in FIG. 4, the control part 28 of the controller B is provided with means 28a for setting a measurement condition, means 28b for computing a coefficient of static friction, and means 28c for computing a coefficient of dynamic friction. Then, the measurement conditions are set in the means 28a for setting a measurement condition by the input from the keyboard 26 and a driving signal is outputted to the actuator 5 and the motor 21 based on the data set in the means 28a for setting a measurement condition. Moreover, in a case where the coefficient of friction of a wet surface is measured, a signal for opening/closing the water supply valve 10 is outputted.

Then, when the means 28b for computing a coefficient of static friction and the means 28c for computing a coefficient of dynamic friction receive the rotation signal from the tachometer 24 and a displacement signal from the displacement gage 15, they are adapted to compute the coefficient of static friction and the coefficient of dynamic friction, respectively, from the rotational speed (in a case of the coefficient of static friction, at the start of rotation), the displacement, and the load applied to the contact bodies 19, and to output the data of computation results to the display 27 to show them.

Here, the personal computer C receives the measurement data from the controller B via a signal line L2 and analyzes the measurement data to obtain the further detailed date of the coefficient of friction.

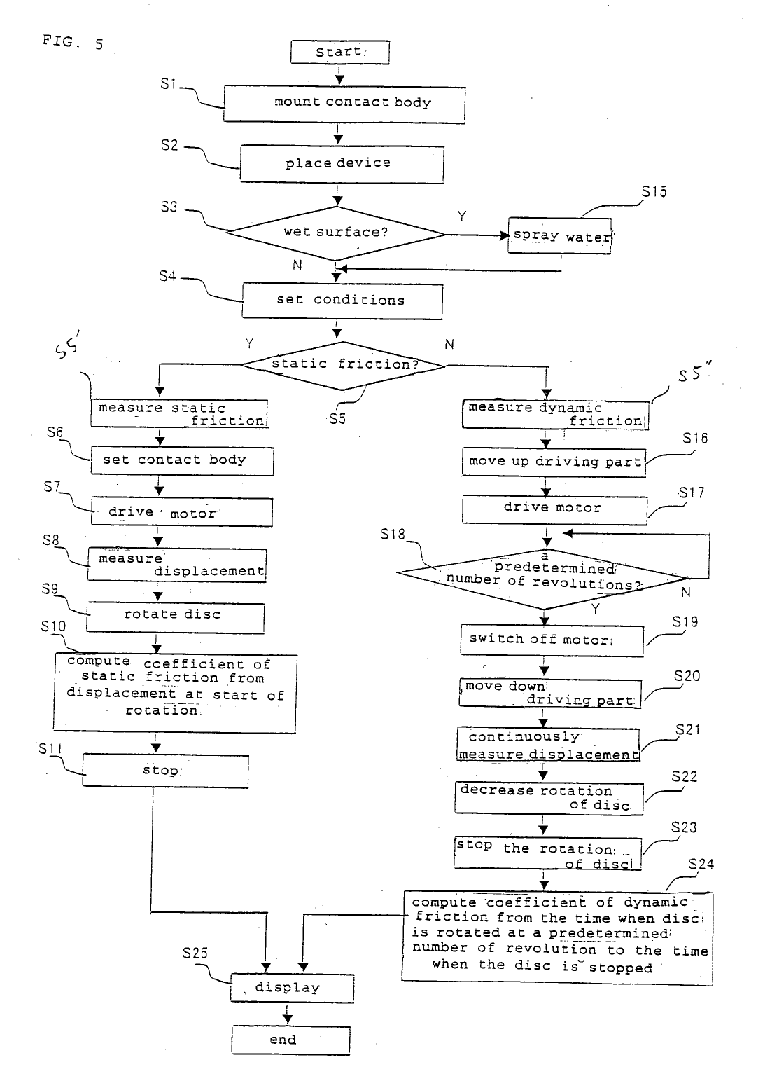

Next, the method for measuring a coefficient of friction in accordance with the present invention will be described based on a flow chart shown in FIG. 5.

### (1) Measurement of a Coefficient of Static Friction

The measuring contact body 19 is mounted on the disc 13 (step S1) and is set so as to apply a previously determined load to the surface G to be measured and then the measuring device body A is placed (step S2). In the next step S3, in a case of measuring a wet surface, the routine advances to step S15, which will be described later, and in a case of measuring a dry surface, the routine advances to step S4. Then, measurement conditions such as the material of the measuring contact body 19, the location of measurement, weather, the date of measurement, static friction or dynamic friction and a measuring person are inputted (step S4).

In a case of measuring the coefficient of static friction (in a case where the answer in step S5 is YES), the routine advances to step S6 and the actuator 5 is operated to move down the friction measuring part 1 to put the contact bodies 19 into contact with the surface G to be measured by a predetermined force.

Then, the motor 21 is started by the output from the control part 28 to drive the driving disc 12 (step S7). A rotational force is transmitted to the disc 13 via the balance spring 14 from the driving disc 12 and the disc 13 is not rotated until the rotational force overcomes the static friction between the contact bodies 19 and the surface G to be measured and the balance spring 14 keeps being displaced. Then, its displacement is measured by the displacement gage 15 and is inputted via the signal line L1 to the control part 28 (step S8).

When the driving force of the driving disc 12 becomes larger than a static frictional force, the disc 13 starts to rotate and the rotation of the disc 13 is detected by the tachometer 24 (step S9). Then, the displacement of the spring 14 at that time is measured by the displacement gage 15 and is inputted to the control part 28.

In the control part 28, the means 28b for computing a coefficient of static friction computes the coefficient of static friction from the displacement at the start of the above-mentioned rotation and the load applied, by the contact bodies 19, to the surface G to be measured (step S10).

When the rotation is detected, driving by the motor 21 is stopped in step S11 and the result of computation of the above-mentioned coefficient of static friction is outputted from the control part 28 to the display 27 or the personal computer C (step S25). This is the end of the measurement of the coefficient of static friction (the coefficient of static friction is determined by averaging the measurement results of several measurements).

### (2) Measurement of a Coefficient of Dynamic Friction

After the measurement conditions are inputted in step S4, in a case of measuring a coefficient of dynamic friction (the answer in the step S5 is NO), the measurement of the coefficient of dynamic friction can be performed in the same way described in the specification of U.S. Pat. No. 4,594,878, for example. That is to say, the lever 4a is pressed down to move up the driving part 2 and is held in this state by the actuator 5 (step S16) Next, the motor is driven (step S17) and when the disc is rotated to a predetermined number of revolutions(step S18: YES), the motor is switched off (step S19) and the actuator 5 is turned off to move down the driving part 2 (step S20). At this time, the contact bodies 19 are put into contact with the surface G to be measured and the displacement of the balance spring 14 caused at this time by the frictional force is continuously measured (step S21). The rotation of the disc 13 is decreased by the frictional force (step S22) and finally, the disc is stopped in rotation (step S23). Then, the coefficient of dynamic friction is computed by the displacement and the number of revolutions from the time when the disc is rotated at a predetermined number of revolutions to the time when the disc is stopped (step S24). This computation result is outputted from the control part 28 to the display 27 or the personal computer C (step S25). This is the end of the measurement of the coefficient of dynamic-friction.

### (3) Measurement of a Coefficient of Friction of a Wet Surface

Moreover, in a case of measuring a coefficient of friction of a wet surface (in a case where the answer in the above-mentioned step S3 is YES), the routine advances to step S15 where the water supply valve 10 is opened by a control performed by the control B to supply water from the water supply tank 7 to the water supply nozzle 9 for a predetermined time or by a predetermined amount to spray the water on the surface G to be measured, and then the routine returns to step S4 and thereafter the measurement is performed in the above-mentioned way to compute the coefficient of static friction and/or the coefficient of dynamic friction.

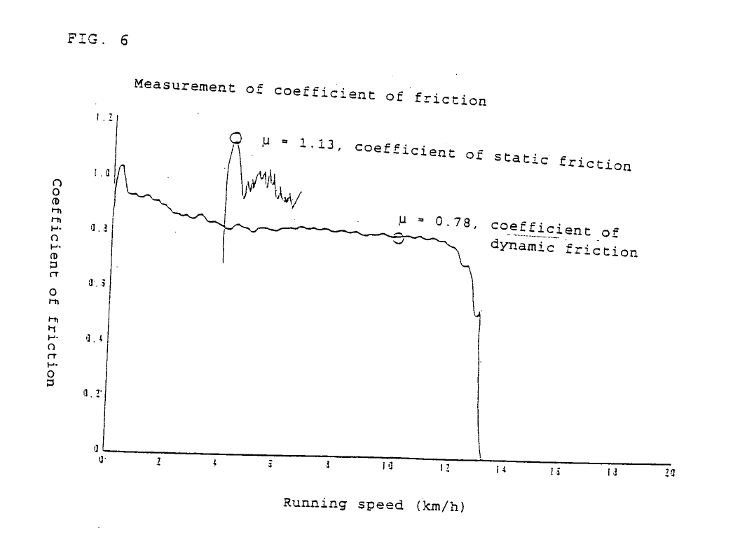

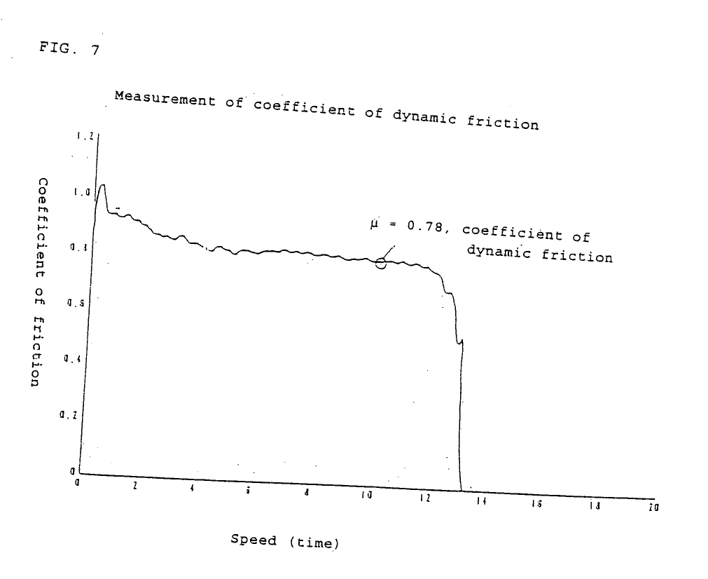

In FIG. 6 and FIG. 7 are shown examples of the measurement of the coefficient of static friction (FIG. 6) and the measurement of the coefficient of dynamic friction (FIG. 7) in accordance with the present invention.

Time or speed is plotted in a horizontal axis and the coefficient of friction computed is plotted in a vertical axis. In the measurement of the coefficient of static friction in FIG. 6, a peak value at the moment of starting to rotate represents a value of the coefficient of static friction (in the example shown in the drawing, μ=1.13) and in the measurement of the coefficient of dynamic friction in FIG. 7, the coefficient of dynamic friction at low speeds (at a point of 10 km/h, μ=0.78) is expressed.

### EFFECTS OF THE INVENTION

The effects of the method for measuring a coefficient of friction in accordance with the present invention will be enumerated in the following.

(1) Since the motor is driven in a state where the contact bodies are in contact with the surface to be measured, it is possible to measure the coefficient of static friction and the coefficient of dynamic friction at low speeds.

(2) Since the water spray nozzle is provided, it is possible to measure the coefficient of friction of not only a dry surface but also a wet surface.

(3) Since the contact bodies in contact with the surface to be measured are removably mounted, it is possible to measure the coefficient of friction for various kinds of materials by replacing the contact bodies.

(4) Since the rubber seats are provided under the base frame, it is possible to measure the coefficient of friction even if the surface to be measured has small bumps and dips or is slightly inclined.

(5) Since the device is small in size and portable, the device is easy to carry and thus the on-the-site measurement can be preformed.

(6) Since the coefficient of friction is computed by the control part, it is possible to obtain the coefficient of friction immediately at the measuring site.

(7) Since the device is automatically driven to perform the measurement, it is possible to shorten a measuring time and to facilitate the measurement, and thus to prevent individual variations in the measurement.

1. A method for measuring a coefficient of friction by using a device for measuring a coefficient of friction,
the device comprising:
a measuring device body including a seat provided at a corner of a bottom surface of a base frame, a holder mounted on the base frame and for supporting a friction measuring part and a driving part, an actuator mounted on the base frame and for moving up and down the friction measuring part and the driving part via the holder, a driving disc fixed to a driving shaft extending from the driving part, a disc rotatably mounted on the lower shaft of the driving disc, the driving disc being joined to the disc by a balance spring, a contact body mounted on a bottom surface of the disc and for measuring a coefficient of friction, and a displacement gage for detecting a displacement of the balance spring; and
a controller including a keyboard for inputting a measurement condition, a display for showing data and a control part,
wherein the measuring device body is placed on a surface to be measured in a state where it is brought into contact with the surface, a force applied at that time by the contact body to the surface to be measured is previously determined, the driving disc is rotated to displace the balance spring, the controller computes a coefficient of static friction from a displacement of the balance spring at the time when the disc starts to rotate and the load of the contact body and shows it on the display, to thereby measure a coefficient of static friction.

2. The method for measuring a coefficient of friction as claimed in claim 1, wherein water is sprayed on the surface to be measured before measurement to measure a coefficient of static friction.

3. The method for measuring a coefficient of friction as claimed in claim 1, wherein the disc is rotated to a predetermined number of revolutions in a state where the disc is pushed up and then the disc is moved down to be put into contact with the surface to be measured to thereby measure a coefficient of dynamic friction by the number of revolutions of a tachometer and the displacement of the balance spring at that time. 14. The method for measuring a coefficient of friction as claimed in claim 3, wherein water is sprayed on the surface to be measured before measurement to measure a coefficient of dynamic friction.
